(19) United States
(12) Patent Application Publication
(10) Pub. No.: US 2025/0371525 A1
(43) Pub. Date: Dec. 4, 2025

(54) SYSTEM AND METHOD FOR PREDICTING BEHAVIORS USING BLOCKCHAIN DATA

(71) Applicant: Deep3 Labs LLC, Hoolywood, FL (US)

(72) Inventors: Daniel Stephens, Fort Lauderdale, FL (US); Jeremy White, Charleston, SC (US)

(21) Appl. No.: 19/219,613

(22) Filed: May 27, 2025

Related U.S. Application Data
(60) Provisional application No. 63/652,521, filed on May 28, 2024.

(51) Int. Cl. G06Q 20/36; G06Q 20/38

(52) U.S. Cl. CPC G06Q 20/3674; G06Q 20/389

(57) ABSTRACT

A system for analyzing blockchain data is disclosed. A user may select a particular model from multiple available models. The selected model may be deployed for use with a particular blockchain. Data may be gathered from one or more digital wallets included in the particular blockchain. The gathered data and the selected model may be used to generate a prediction that may be sent to the user.

### CROSS-REFERENCE TO RELATED APPLICATIONS

The present application claims the benefit of U.S. Provisional Application No. 63/652,521, entitled “SYSTEM AND METHOD FOR PREDICTING BEHAVIORS USING BLOCKCHAIN DATA,” filed May 28, 2024, the content of which is incorporated by reference herein in its entirety for all purposes.

### TECHNICAL FIELD

This disclosure relates generally to a blockchain. More specifically, this disclosure relates to a system and method for retrieving information from a blockchain and making predictions using the retrieved information and application-specific machine-learning models.

### BACKGROUND

A blockchain is a distributed database that maintains a continuously-growing list of records, called blocks, that may be linked together to form a chain. Each block in the blockchain may contain a timestamp and a link to a previous block and/or record. The blocks may be secured from tampering and revision. In addition, a blockchain may include a secure transaction ledger database shared by parties participating in an established, distributed network of computers. A blockchain may record a transaction (e.g., an exchange or transfer of information) that occurs in the network, thereby reducing or eliminating the need for trusted/centralized third parties. In some cases, the parties participating in a transaction may not know the identities of any other parties participating in the transaction but may securely exchange information. Further, the distributed ledger may correspond to a record of consensus with a cryptographic audit trail that is maintained and validated by a set of independent computers. A blockchain may store a cryptocurrency and/or a non-fungible token.

### SUMMARY

Various embodiments of a blockchain analysis system are disclosed. Broadly speaking, a user may select a particular model of a plurality of models included in the blockchain analysis system. The blockchain analysis system may deploy the particular model for use with a particular blockchain to gather respective data from one or more digital wallets associated with the particular blockchain. The blockchain analysis system may generate at least one prediction using the particular model and the respective data from the one or more digital wallets, and send the at least one prediction to the user.

### NOTATION AND NOMENCLATURE

Various terms are used to refer to particular system components. Different entities may refer to a component by different names-this document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect or direct connection. Thus, if a first device couples to a second device, that connection may be through a direct connection or through an indirect connection via other devices and connections.

The terminology used herein is for the purpose of describing particular example embodiments only, and is not intended to be limiting. As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer or section from another element, component, region, layer or section. Terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the example embodiments. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read-only memory (ROM), random-access memory (RAM), a hard disk drive, a compact disc (CD), a digital video disc (DVD), solid-state drives (SSDs), flash memory, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many, if not most, instances, such definitions apply to prior as well as future uses of such defined words and phrases.

A “private key” may refer to a cryptographic large, randomly-generated number with multiple digits represented as a string of alphanumeric characters. The private key may be used to sign transactions and to prove ownership of a blockchain address. The private key may encrypt and decrypt data.

A “public key” may refer to a cryptographic key that can be obtained and used by anyone to encrypt messages intended for a particular recipient, such that the encrypted messages can be deciphered only by using a second key that is known only to the recipient, e.g., having the private key.

A “digital wallet” may consist of a set of public addresses and private keys. Any device may deposit cryptocurrency in a public address, but funds cannot be removed from an address without the corresponding private key.

A “blockchain” may refer to a distributed database that maintains a continuously-growing list of records, called blocks, that may be linked together to form a chain.

A “blockchain system” may refer to a group of nodes that cooperate to maintain and build a blockchain according to a protocol.

A “node” may refer to a computing device participating in the blockchain system, and that is connected to and interacts with the blockchain.

A “hash” may refer to an output of a cryptographic function used in securing information in a blockchain.

A “consensus algorithm” may refer to a process used to achieve approval or agreement on a single data value in a distributed system.

The term “feedback loop” may refer to a mutually dependent relationship between two parties in a given system.

The term “proof of work” may refer to a cryptographic process to ensure data security and/or uniformity.

The term “transparent” or “transparency” may refer to a property of a gemstone or material that enables at least some information (e.g., etching, laser mark, engraving, etc.) included within the gemstone or material to be visible. In some embodiments, the information may not be visible to the naked eye (e.g., less than 0.1 millimeter in size). In some embodiments, the information may be visible to the naked eye (e.g., greater than 0.1 millimeters in size).

A “proof of record” may refer to a compression process using the consensus algorithm designed to create a tiered, access-oriented, and adjustable blockchain architecture used by the blockchain system described herein.

The term “SHA” may refer to Secure Hash Algorithm.

The term “SHA-2” may refer to a set of cryptographic hash functions designed by the United States National Security Agency.

The term “SHA256” may refer to a member of the SHA-2 cryptographic hash functions and may generate an almost-unique 256-bit data signature.

### BRIEF DESCRIPTION OF THE DRAWINGS

For a more complete understanding of this disclosure and its advantages, reference is now made to the following description, taken in conjunction with the accompanying drawings, in which:

FIG. 1 is a block diagram depicting a system for analyzing blockchain data.

FIG. 2 is a block diagram depicting model development for the system for analyzing blockchain data.

FIG. 3 is a block diagram depicting governance of the system for analyzing blockchain data.

FIG. 4 is a block diagram depicting detecting attacks and high-frequency addresses in a blockchain.

FIG. 5 is a block diagram depicting grouping digital wallets included in a blockchain.

FIG. 6 is a block diagram depicting agent-based trading using digital wallets included in a blockchain.

FIG. 7 is a block diagram depicting cluster-based trading using digital wallets included in a blockchain.

FIG. 8 is a block diagram depicting an embodiment of a computer system.

FIG. 9 is a flow diagram depicting an embodiment of a method for analyzing blockchain data.

FIG. 10 is a flow diagram depicting an embodiment of a method for adding a model to a system for analyzing blockchain data.

FIG. 11 is a flow diagram depicting an embodiment of a method for governing a system for analyzing blockchain data.

FIG. 12 is a flow diagram depicting an embodiment of a method for generating advertising materials using a system for analyzing blockchain data.

FIG. 13 is a flow diagram depicting an embodiment of a method for detecting front-run attacks in a blockchain system.

FIG. 14 is a flow diagram depicting an embodiment of a method for identifying high-frequency trading addresses in a blockchain.

FIG. 15 is a flow diagram depicting an embodiment of a method for grouping digital wallets included in a blockchain.

FIG. 16 is a flow diagram depicting an embodiment of a method for cluster-based trading using digital wallets included in a blockchain.

FIG. 17 is a flow diagram depicting an embodiment of a method for agent-based trading using digital wallets included in a blockchain.

FIG. 18 is a block diagram depicting decentralized revenue sharing using tokens associated with a blockchain.

FIG. 19 is a flow diagram depicting an embodiment of a method for decentralized revenue sharing for a blockchain.

### DETAILED DESCRIPTION

As the World Wide Web evolved from Web 1 to its current state, i.e., Web 2, strides were made in the areas of user-generated content and usability for end users. In Web 2, however, data is stored and maintained by centralized companies resulting in user-generated data not being owned by the user that originally generated the data.

While Web 3 has not fully taken shape, it has the potential to change how business is done in that data is decentralized and not controlled by companies or governments. One technique to implement decentralized data in Web 3 is the use of blockchains.

Blockchains may refer to a distributed ledger maintained by and stored on one or more computing devices in a decentralized fashion. A blockchain may provide access to immutable records of information. Blockchains may be published to the public. A blockchain may be stored on numerous computing devices connected via a network in a cloud-based computing system. Accordingly, since numerous computing devices (e.g. nodes) may alter the blockchain (e.g., by adding a new block), security is an important consideration when implementing a blockchain. Conventionally, to secure the blockchain, a proof of work is used that ensures reliable evidence that a significant amount of processing resources (such as time and/or compute resources) was used during the creation of a new block to be added to the blockchain. The Bitcoin implementation of blockchain requires a node to use processing resources to find a nonce value that, when hashed with the rest of a block header, results in a hash value that has a predetermined number of leading zeroes.

Also, some blockchain technologies, like Bitcoin, provide blockchains directly to all the participating nodes in a blockchain system. The blockchains may continue to grow in size as nodes add blocks for an unrestricted amount of time. There are different kinds of blockchains, such as permission-less and permissioned. In a permission-less blockchain, any entity may participate without an identity. In a permissioned blockchain, each entity that participates in the blockchain is identified and known. An example of a permissioned blockchain is a distributed ledger (e.g., a hyperledger). The permissions cause the participating nodes to view only the appropriate records of transactions in the distributed ledger. Programmable logic may be implemented as rules and/or smart contracts that are executed on the distributed ledger. In some embodiments, the rules may be analytics-based and may specify scenarios when updates to the distributed ledger are to be made. Using the analytics-based rules may make each node an active participant by updating the distributed ledger at specified times.

A smart contract may refer to a computer protocol with one or more functions capable of digitally facilitating, verifying, and/or assisting with transactions associated with the blockchain. The smart contract may include a function configured to authorize and/or authenticate a transaction request made by a user, a function configured to add content to the distributed ledger (e.g., a non-fungible token, a cryptocurrency, and/or the like), a function configured to verify the content of the blockchain, a function configured to allow certain authorized users to view the content of the blockchain, a function configured to incentivize one or more transactions, and/or the like.

A non-fungible token (NFT) may refer to a non-interchangeable unit of data stored on a blockchain that can be sold and/or traded. In some embodiments, types of NFT data units may be associated with digital files such as photos, images, videos, and/or audio. NFTs differ from cryptocurrencies, such as Bitcoin, because cryptocurrencies are fungible (interchangeable) and NFTs are non-fungible.

A cryptocurrency is a digital or virtual currency that is secured by cryptography and stored on a blockchain. Cryptocurrency is a form of a digital asset based on a network that is distributed across a large number of computers. Cryptocurrency transactions may be governed via a smart contract that controls transfers. Private keys may be used to sign transactions to enable the cryptocurrency to move from one digital wallet to another digital wallet. A public key may be used by the receiving digital wallet to verify the transfer is valid.

Decentralization of data, however, is not without problems. Currently, most decentralized applications (referred to as “dApps”) function in an identical fashion independent of a connected user, any prior interactions with the dApps the connected user had, and the conversion objects of the dApps. Users have come to expect a high degree of personalization in current online experiences. Before dApps are widely adopted, they are going to need to provide a similar user experience to what is currently available. Without a personalized user experience, dApps will not be able to achieve online conversion rate goals. As used herein, conversion rate refers to a percentage of users, e.g., visitors to a website, which take a desired action, such as making a purchase. A high conversion rate may be indicative of an effective user experience.

The embodiments illustrated in the drawings and described below may provide techniques for retrieving and analyzing data from a blockchain to take advantage of the decentralized nature of blockchains. By using machine-learning models to analyze the data from the blockchain, personalized user experiences that can result in high conversion rates may be achieved in a decentralized web environment.

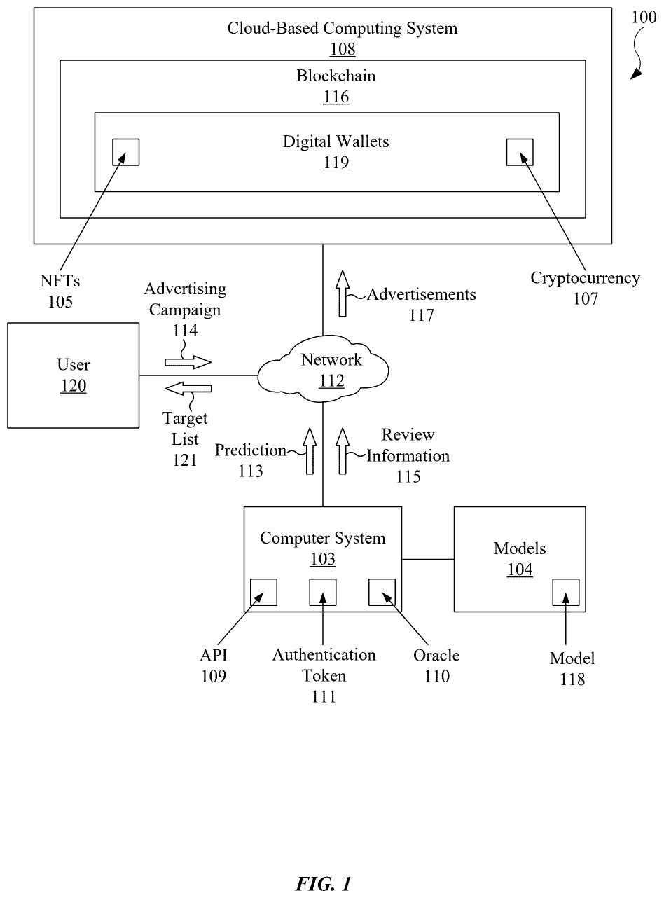

A block diagram of a blockchain analysis system is depicted in FIG. 1. As illustrated, blockchain analysis system 100 (also referred to as a blockchain analysis ecosystem) includes cloud-based computing system 108, computer system 103, and models 104. In various embodiments, computer system 103 is coupled to cloud-based computing system 108 via network 112.

In some embodiments, cloud-based computing system 108 may include one or more servers that form a distributed computing architecture. The servers may be a rackmount server, a router computer, a personal computer, a portable digital assistant, a mobile phone, a laptop computer, a tablet computer, a camera, a video camera, a netbook, a desktop computer, a media center, any other device capable of functioning as a server, or any combination of the above. Each of the servers may include one or more processing devices, memory devices, data storage, and/or network interface cards. The servers may be in communication with one another via any suitable communication protocol.

Cloud-based computing system 108 may include blockchain 116. Blockchain 116 may refer to a distributed ledger that is decentralized and controlled by peer-to-peer authorization. For example, to add a block to blockchain 116, a consensus protocol may be used where more than a threshold (e.g., more than 75%) of the nodes on blockchain 116 agree to allow a block to be added to blockchain 116. A node may refer to a computing device (e.g., server) that has an instance of blockchain 116 stored in memory and/or executed by a processing device.

Blockchain 116 may store one or more blocks (denoted as “digital wallets 119”) that each have a respective address. There may also be private and public keys associated with the blocks and users that perform transactions using their computing devices. Further, each block may be associated with a smart transaction that controls the transactions and records each and every transaction in blockchain 116. In some embodiments, the blocks may store NFTs 105. NFTs 105 may further store images, audio, video, or the like. In one example, NFTs 105 may store a digital model of a jewelry design. Blockchain 116 may also include one or more blocks that store cryptocurrency 107. In various embodiments, cryptocurrency 107 may be associated with a number of units and an identifier for cryptocurrency 107. Both NFTs 105 and the cryptocurrency 107 may include metadata associated with an owner of NFTs 105 and cryptocurrency 107. In some embodiments, any information associated with NFTs and/or cryptocurrency 107 may be stored as metadata in the respective block of blockchain 116.

In various embodiments, user 120 may select model 118 from models 104. Computer system 103 may, in some embodiments, be configured to provide a visual display of models 104 to allow user 120 to select model 118 via a “point and click” method. In some cases, computer system 103 may be further configured, in response to user 120 selecting model 118, to send authentication token 111 to user 120. In various embodiments, authentication token 111 is associated with application programming interface endpoint 109 (denoted as “API 109”) which is associated with model 118. Although an API authentication token is described in conjunction with the embodiment of FIG. 1, in other embodiments, other methods of authentication are possible and contemplated. For example, authentication may be based on possession of a particular blockchain token and proving control of a wallet that possess the particular blockchain token by signing a transaction. In some cases, computer system 103 may send review information 115 to user 120 in response to user 120 selecting model 118. Review information 115 may include different reviews from other users regarding the performance of model 118. It is noted that although authentication token 111 is depicted as being associated with API 109, in other embodiments, authentication token 111 can be associated with a blockchain oracle or any other suitable interface for accessing a blockchain.

Computer system 103 is also configured to deploy model 118 for use with blockchain 116. In various embodiments, to deploy model 118, computer system 103 may be further configured to retrieve data from one or more of digital wallets 119 included in blockchain 116. Computer system 103 may be configured to retrieve the data from the one or more digital wallets 119 using API 109 or oracle 110. As used herein, an oracle refers to an entity that connects a blockchain to an external system for the purpose of executing smart contracts based on inputs from outside the blockchain. Although oracle 110 is depicted as being part of computer system 103, in other embodiments, oracle 110 can be included in a different computer system with which computer system 103 can communicate via network 112.

In various embodiments, computer system 103 may be configured to analyze the data retrieved from the one or more of digital wallets 119 using model 118. Computer system 103 can be configured to generate prediction 113, which may be relayed to user 120 via network 112, based on the analysis of the retrieved data. Although only a single prediction is shown in FIG. 1, in other embodiments, computer system 103 can generate any suitable number of predictions for a given model of models 104.

In some embodiments, prediction 113 can include a predicted duration that a given digital wallet of digital wallets 119 will hold a given token. In other embodiments, prediction 113 can include a prediction that a particular digital wallet of digital wallets 119 is machine controlled. In various embodiments, prediction 113 may identify, based on respective preferences, a subset of digital wallets 119. Such a subset may, in certain embodiments, be used for targeted advertising.

In various embodiments, user 120 may generate advertising campaign 114. In some cases, user 120 may generate advertising campaign 114 with assistance from a chatbot or other similar application executing on computer system 103. As part of generating advertising campaign 114, user 120 may specify a blockchain, e.g., blockchain 116, which includes one or more digital wallets that will be a target of the advertising campaign. In some embodiments, user 120 may additionally specify a budget for advertising campaign 114.

Computer system 103 may, in different embodiments, be configured to assist user 120 in the generation of advertisements 117. In some embodiments, computer system 103 may be configured to execute a generative artificial-intelligence tool that prompts user 120 and user responses to the prompts to generate advertisements 117. In some cases, the generative artificial-intelligence tool may suggest and generate variations to advertisements 117.

In some embodiments, computer system 103 may, with or without assistance from user 120, be configured to generate target list 121. In various embodiments, target list 121 may include a list of addresses corresponding to a subset of digital wallets 119. Target list 121 may, in some cases, be based on an analysis of previous transactions associated with digital wallets 119. Once target list 121 has been generated, computer system 103 may deliver advertisements 117 to the digital wallets included in target list 121 via e-mail message, text message, NFT, or any other suitable communication method.

Computer system 103 is also configured to monitor the success of advertising campaign 114. In various embodiments, to monitor the success of advertising campaign 114, computer system 103 may be further configured to determine a conversion rate for the digital wallets included in target list 121, and compare the conversion rate to a threshold value.

In cases where the conversion rate is less than a threshold value, computer system 103 may repeat any of the operations described above, including re-generating advertisements 117, in order to improve the conversion rate. It is noted that computer system 103 may continue to repeat the operations until the conversion rate exceeds the threshold value, or a budget for advertising campaign is exceeded.

Computer system 103 may, in some embodiments, be implemented using a processor circuit or multiple processor core circuits. In various embodiments, such processor circuits or processor core circuits may be configured to execute software or programming instructions that cause computer system 103 to perform the functions and operations described herein.

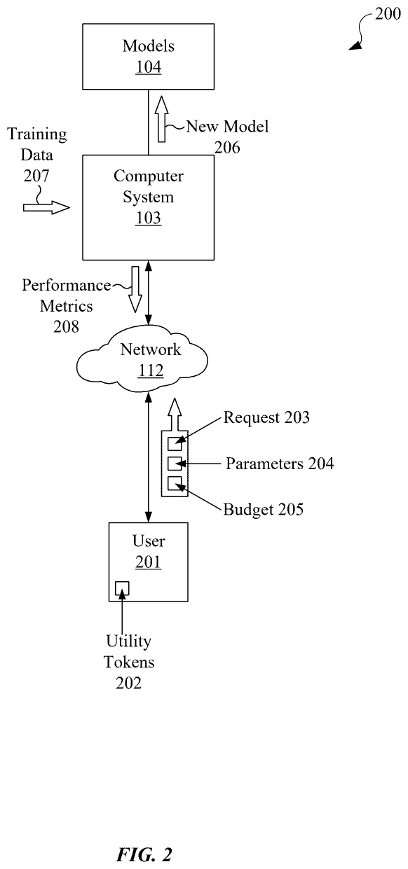

Having a dynamic library of models can allow a blockchain analysis system to provide a wider range of users accessing data analysis capabilities. In cases where a user is looking for a particular type of analysis or prediction, and there is no model that supports what the user desires, the user can generate and add a model to the blockchain analysis system. A block diagram illustrating the addition of a model to a blockchain analysis system is depicted in FIG. 2.

As illustrated in the embodiment of FIG. 2, user 201 sends, via network 112, request 203 to computer system 103. In various embodiments, request 203 is a request for new model 206 to be generated and added to models 104. In some cases, user 201 may define request 203 via a webpage interface to computer system 103. In other embodiments, information for generating new model 206 may be gathered by computer system 103 using a generative artificial intelligence tool, e.g., ChatGPT, which can prompt user 201 for additional details based on answers to initial questions. It is noted that the generative artificial intelligence tool may be included as part of software executed by computer system 103 or the generative artificial intelligence tool may be developed by a third party and executed on a computer system different than computer system 103.

In some cases, user 201 may additionally specify budget 205 for the generation of new model 206. Budget 205, which may be specified as a number of utility tokens, may affect an amount of training performed on new model 206, the complexity of new model 206, or any other suitable operation included in the generation of new model 206.

In various embodiments, user 201 may additionally have to provide a number of utility tokens 202 as payment for the development of new model 206. The number of utility tokens 202 may be based, at least in part, on a complexity of new model 206, an amount of training specified by user 201 for new model 206, or any other suitable metric.

User 201 may additionally send parameters 204 along with request 203 to computer system 103. In various embodiments, parameters 204 may include training parameters such as a size of new model 206, a number of passes through training data 207 to employ, or any other suitable parameter associated with training a machine-learning model.

Computer system 103 may be configured to train new model 206 using training data 207. In some cases, computer system 103 may train new model 206 according to parameters 204. In some embodiments, training new model 206 may include adjusting one or more parameters included in new model 206 based on training data 207. Alternatively, or additionally, computer system 103 may be configured to make a prediction using new model 206 operating on training data 207, and adjusting new model 206 using results of the prediction.

In some embodiments, computer system 103 is configured to generate performance metrics 208 associated with new model 206. Performance metrics 208 may, in various embodiments, include execution time for making a prediction, accuracy of a prediction, or any other suitable metric of the performance of new model 206.

User 201 may, in some embodiments, receive performance metrics 208 from computer system 103 via network 112. In such cases, user 201 may review performance metrics 208. In some embodiments, user 201 or computer system 103 may halt the inclusion of new model 206 into models 104 in response to a determination that one or more of performance metrics 208 indicate undesirable performance.

In cases where performance metrics 208 indicate a desired level of performance, computer system 103 may release new model 206 for inclusion into models 204. In such cases, computer system 103 may, as described below, initiate a vote regarding the inclusion of new model 206 using governance utilities within the blockchain analysis system. For example, computer system 103 may initiate a vote to determine an amount of collateral to associate with new model 206, a royalty to be associated with the use of new model 206, and the like.

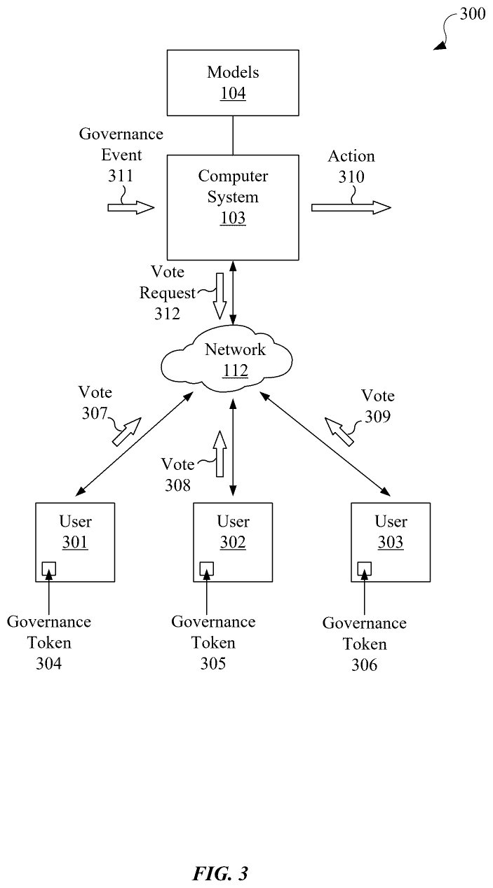

In some cases, a blockchain analysis system may function as a decentralized autonomous organization (“DAO”), which may be managed, at least in part, by a decentralized computer system. In some cases, some of the users of the DAO may manage, or govern, the overall system by voting on different events that occur within the system. A block diagram illustrating such governance is depicted in FIG. 3.

As illustrated in FIG. 3, computer system 103 is configured to detect governance event 311. In various embodiments, governance event 311 may include adding a new model to models 104, or removing and de-collateralizing an existing model in models 104. In other embodiments, governance event 311 may include changes in prices for performing various tasks within blockchain analysis system 100, changes in royalties for different models included in models 104, gaining access to a new data source, and the like.

In response to the detection of governance event 311, computer system 103 may be further configured to send, via network 112, vote request 312 to users 301-303. Although only three users are depicted in the embodiment of FIG. 3, in other embodiments, any suitable number of users may be employed.

In various embodiments, users 301-303 may be a subset of users for blockchain analysis system 100 who have a governance token in their possession. For example, user 301 possesses governance token 304, while users 302 and 303 possess governance tokens 305 and 306, respectively. It is noted that users of blockchain analysis system 100 that do not possess a governance token may not be allowed to vote on governance-related issues. In some embodiments, in order to vote, users 301-303 may have to send respective ones of governance tokens 304-306 to a smart contract in order to be allowed to vote on a governance-related issue. In some cases, different smart contracts may be used for different governance-related issues.

In response to receiving vote request 312, users 301-303 send, via network 112, votes 307-309, respectively to computer system 103. In various embodiments, computer system 103 may weigh votes from different users differently. In some cases, computer system 103 may tally the votes according to one of various voting methods, such as quadratic voting.

Based on votes 307-309, computer system 103 is configured to perform action 310 for blockchain analysis system 100. In various embodiments, action 310 may include removing a model from models 104, adding a new model to models 104, changing a royalty for a given model included in models 104, or any other suitable action corresponding to vote request 312.

It is noted that while the governance operation illustrated in FIG. 3 is depicted as a standalone operation, in various embodiments, governance operations may be performed in parallel with any of the operations described above in regard to FIG. 1 or 2 or the flow diagrams described below.

In some cases, one or more digital wallets in a blockchain may be controlled by a program or “bot.” Such bots can be programmed to take advantage of changes in the values of tokens by performing a large number of transactions. In other cases, the bots can be programmed to perform front-run or “sandwich” attacks. As used herein, a sandwich attack refers to when a bot or nefarious trader looks for a pending transaction, and then places one order before the transaction and one order after the transaction. By placing orders before and after the target transaction, the nefarious trader may be manipulating the price of an asset associated with the target transaction.

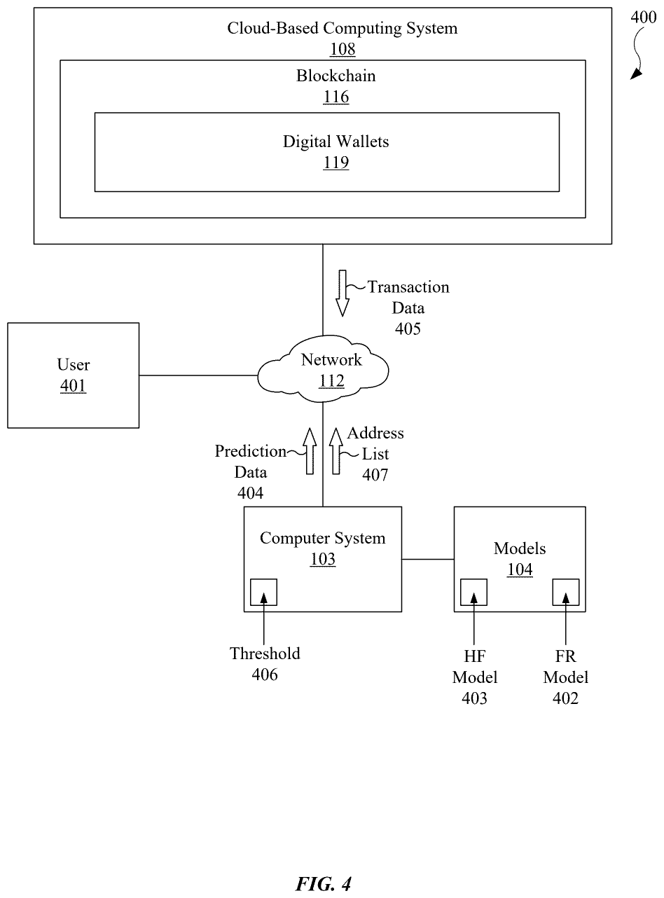

Detecting sandwich attacks and the like is a first step to limit the problems such attacks can present for decentralized finance protocols and services. A block diagram depicting the detection of attacks using a blockchain analysis system is shown in FIG. 4.

As depicted in the embodiment of FIG. 4, computer system 103 is configured to scan digital wallets 119 included in blockchain 116 and implemented on cloud-based computing system 108 to generate transaction data 405. In various embodiments, transaction data 405 may include date and time information for a given transaction, a type of token involved in a transaction, or any other suitable information related to the acquisition or selling of tokens in blockchain 116.

In some embodiments, computer system 103 is configured to determine one or more of digital wallets 119 that are associated with corresponding front-run attacks. To determine if a given digital wallet of digital wallets 119 is associated with a front-run attack, computer system 103 may be configured to analyze transaction data 405 using front-run model 402 (denoted as “FR model 402”). In various embodiments, FR model 402 may be implemented as a machine-learning model that has been trained with sample transaction data.

In some cases, user 401 may provide threshold 406 to computer system 103. In various embodiments, computer system 103 may be configured to compare a number of times a particular digital wallet performs a front-run attack to threshold 406. By employing threshold 406, digital wallets that only occasionally perform front-run attacks can be excluded from further processing of transaction data 405 in order to improve the prediction of future front-run attack issues.

Computer system 103 is also configured to generate prediction data 404 which includes respective likelihoods that the one or more digital wallets will be involved in future front-run attacks. In various embodiments, computer system 103 is further configured to generate address list 407 which includes addresses corresponding to the one or more digital wallets. In some embodiments, computer system 103 may send address list 407 to user 401 via network 112. In different embodiments, computer system 103 may be configured to perform a blocking action or other operation on at least one of the addresses included in address list 407 in response to a request from user 401.

In addition to predicting future front-run attacks, computer system 103 may also be able to identify and predict high-frequency trading digital wallets. High-frequency trading can, in some embodiments, be indicative of digital wallets controlled by bots or other applications. To identify high-frequency trading digital wallets, computer system 103 is configured to scan digital wallets 119 to generate transaction data 405.

Computer system 103 is also configured to identify at least one of digital wallets 119 associated with high-frequency trading using transaction data 405 and high-frequency model 403 (denoted as “HF model 403”). In various embodiments, HF model 403 may be implemented using a machine-learning model trained on sample transaction data. In some embodiments, to identify the at least one of digital wallets 119, computer system 103 may be further configured to determine how long a given digital wallet of digital wallets 119 holds a given token.

In various embodiments, computer system 103 may be configured to include addresses associated with particular ones of digital wallets 119 in address list 407, which is sent to user 401 via network 112. It is noted that, in different embodiments, computer system 103 may generate different address lists for different checks, e.g., a check for high-frequency trading. As described above, computer system 103 may be configured to perform blocking actions against one or more of the addresses included in address list 407.

Although only two different checks, e.g., front-run attack check, are described in FIG. 4, in other embodiments, computer system 103 may be configured to implement any suitable number of checks using corresponding ones of models 104, and take corresponding actions towards digital wallets identified as likely candidates for causing problems within blockchain 116.

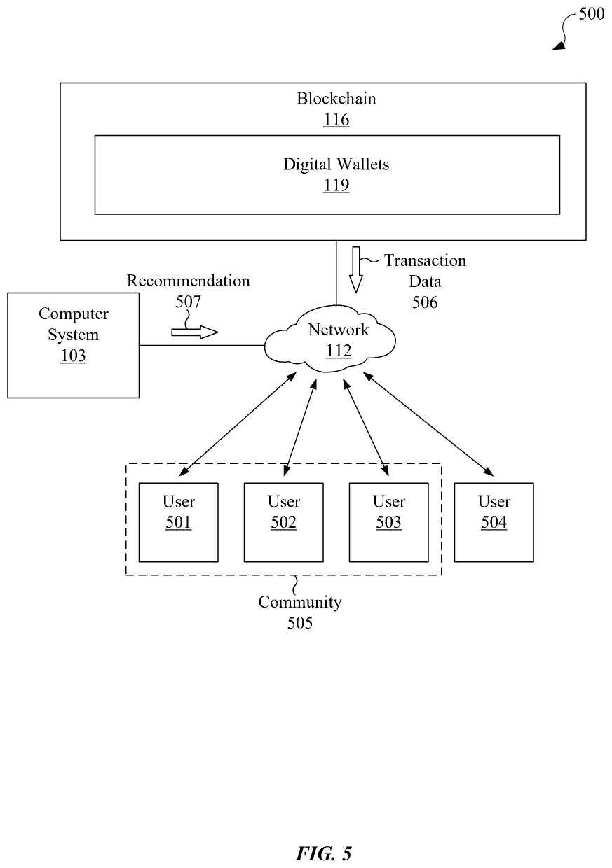

Turning to FIG. 5, a block diagram depicting grouping different users of a blockchain is illustrated. In some cases, different users may have common preferences, actions, and the like. For example, a subset of the users associated with a blockchain may prefer to hold tokens longer than other users associated with the blockchain. By identifying such groups, targeted recommendations may be generated based on respective preferences of the groups.

Computer system 103 is configured to scan digital wallets 119 included in blockchain 116 to generate transaction data 506. In some cases, computer system 103 is configured to scan digital wallets 119 in response to the addition of a new digital wallet to digital wallets 119.

In various embodiments, users 501-504 are associated with one or more of digital wallets 119. In some cases, a given one of users 501-504 may be associated with more than one digital wallets of digital wallets 119. Computer system 103 is further configured to identify a subset of users 501-504 (denoted as community 505, which includes users 501-503) based on respective transaction histories of corresponding digital wallets of digital wallets 119. In some embodiments, users 501-503 may include a common preference for a time a token is held, a frequency of transactions, or any other suitable common factor. In other embodiments, computer system 103 may employ a particular one of models 104 to identify community 505. It is noted that the particular one of models 104 may be implemented using a machine-learning model that is trained with training data that includes one or more common preferences between at least two sample users.

Computer system 103 is also configured to generate recommendation 507 for users included in community 505. In various embodiments, recommendation 507 may include a recommendation to participate in a particular transaction. In other embodiments, recommendation 507 may include a suggestion to read a particular news article, social media post, or the like. Computer system 103 may be configured to send recommendation 507 to users 501-503 via network 112.

Although only a single community (or “subset”) of users is depicted in the embodiment of FIG. 5, in other embodiments, computer system 103 may be configured to identify multiple communities within a group of users associated with blockchain 116. In such cases, a given one of users 501-504 may be included in multiple communities.

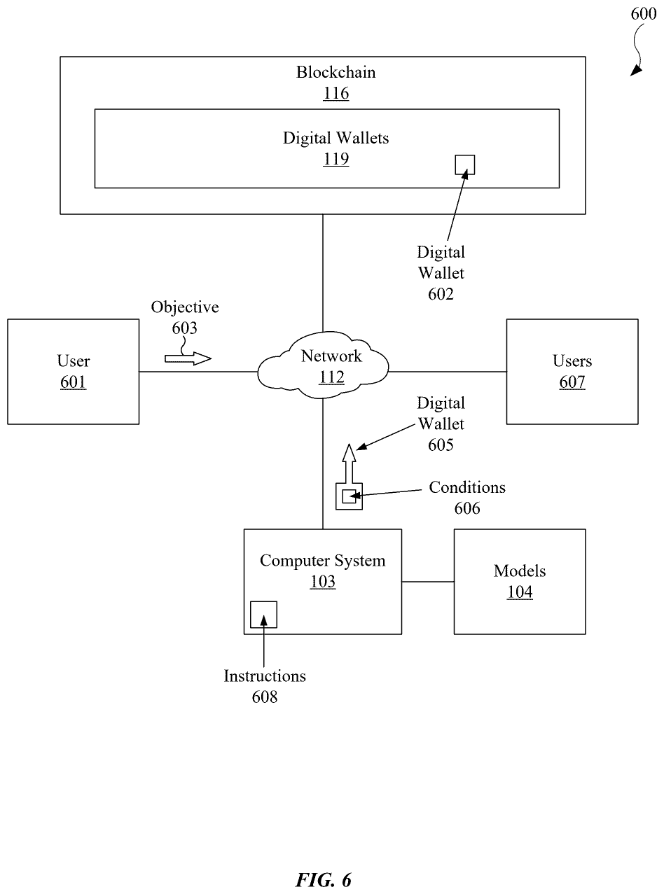

Turning to FIG. 6, a block diagram depicting agent-based trading using digital wallets included in a blockchain is illustrated.

In various embodiments, user 601 selects digital wallet 602 from digital wallets 119 included in blockchain 116. In some cases, user 601 may send information indicative of the selection of digital wallet 602 to computer system 103 via network 112.

Computer system 103 may be configured to perform an analysis of digital wallet 602 based on instructions 608. In some cases, instructions 608 may be supplied by user 601 and may include generating one or more outputs using one or more of models 104. In some embodiments, to perform the analysis, computer system 103 may be further configured to track a number of transactions associated with digital wallet 602.

In various embodiments, user 601 can define objective 603 using a result of the analysis performed by computer system 103. Objective 603 can include any suitable objective for the operation of a digital wallet, e.g., digital wallet 602. For example, objective 603 may include a target number of trades, a target net value for the digital wallet, and the like.

Computer system 103 may be further configured, on behalf of user 601, to deploy digital wallet 605. In various embodiments, to deploy digital wallet 605, computer system 103 may be additionally configured to add digital wallet 605 to digital wallets 119 in blockchain 116. Although computer system 103 is depicted as deploying a single digital wallet, in other embodiments, computer system 103 may be further configured to deploy multiple digital wallets for users 607. In some cases, one or more of the digital wallets may include conditions 606 for use by users 607.

Computer system 103 can also be configured to operate digital wallet 605 based on objective 603. In various embodiments, to operate digital wallet 605, computer system 103 may perform trades, purchase NFTs, etc., in order to achieve objective 603.

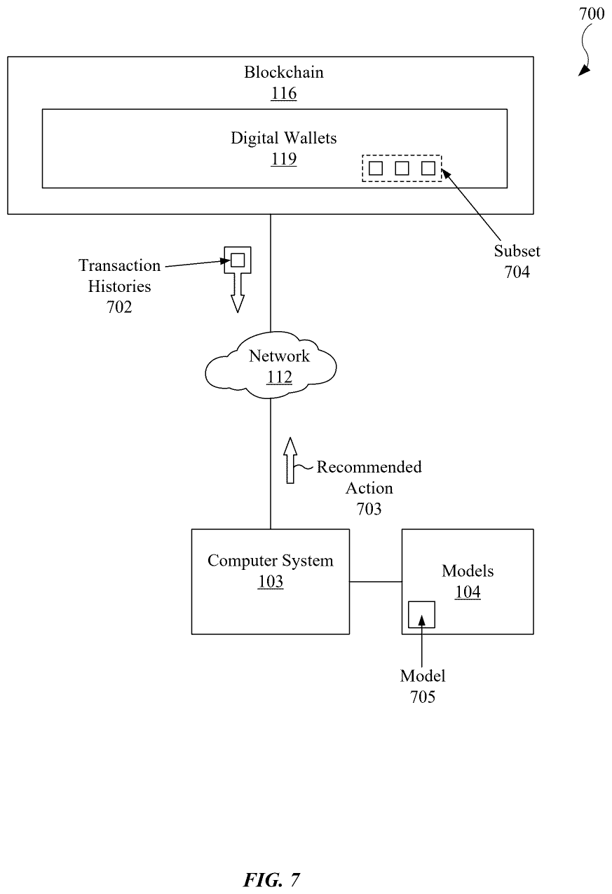

Turning to FIG. 7, a block diagram depicting cluster-based trading using digital wallets included in a blockchain is illustrated.

Computer system 103 is configured to scan digital wallets 119 to generate transaction histories 702. In some embodiments, computer system 103 may be configured to scan digital wallets 119 in response to a request received from a user, the addition of a new digital wallet, or any other suitable condition.

Computer system 103 can be further configured, using transaction histories 702 and model 705 of models 104, to determine subset 704 of digital wallets 119. To determine subset 704, computer system 103 may be further configured to compare transaction histories 702 to a target transaction history. In some cases, the target transaction history may correspond to a transaction history of a given one of digital wallets 119. In other embodiments, to compare transaction histories 702, computer system 103 may also be configured to determine a number of transactions that match between the target transaction history and a given transaction history of transaction histories 702. In some cases, model 705 may be a machine-learning model.

In various embodiments, computer system 103 may be configured to detect, using model 705, network activity in network 112 associated with subset 704. In other embodiments, the network activity in network 112 associated with subset 704 may include transfers of data packets between different digital wallets included in subset 704.

In some embodiments, computer system 103 can be configured, using model 705 and based on the network activity, to generate recommended action 703 for a given digital wallet of subset 704. In some cases, recommended action 703 may include selling or trading a given NFT, or any other suitable action.

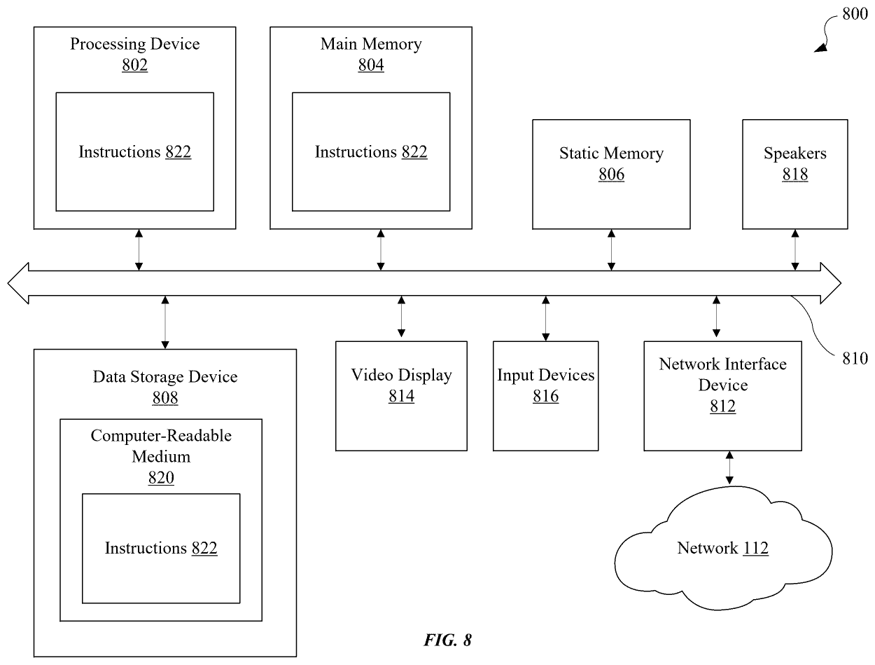

FIG. 8 illustrates example computer system 800 which can perform any one or more of the methods described herein in accordance with one or more aspects of the present disclosure. In one example, computer system 800 may correspond to computer system 103, or a server included in cloud-based computing system 108 as depicted in FIG. 1. Computer system 800 may be connected (e.g., networked) to other computer systems in a LAN, an intranet, an extranet, or the Internet. Computer system 800 may operate in the capacity of a server in a client-server network environment. Computer system 800 may be a personal computer (PC), a tablet computer, a wearable (e.g., wristband), a set-top box (STB), a personal Digital Assistant (PDA), a mobile phone, a camera, a video camera, an electronic device identification sensor, or any device capable of executing a set of instructions (sequential or otherwise) that specify actions to be taken by that device. Further, while only a single computer system is illustrated in FIG. 8, the term “computer” shall also be taken to include any collection of computers that individually or jointly execute a set (or multiple sets) of instructions to perform any one or more of the methods discussed herein.

Computer system 800 includes processing device 802, main memory 804 (e.g., read-only memory (ROM), flash memory, dynamic random access memory (DRAM) such as synchronous DRAM (SDRAM)), static memory 806 (e.g., solid state drive (SSD), flash memory, static random access memory (SRAM)), and data storage device 808, which communicate with each other via a bus 810.

Processing device 802 represents one or more general-purpose processing devices such as a microprocessor, a central processing unit, or the like. More particularly, processing device 802 may be a complex instruction set computing (CISC) microprocessor, a reduced instruction set computing (RISC) microprocessor, a very long instruction word (VLIW) microprocessor, or a processor implementing other instruction sets or processors implementing a combination of instruction sets. Processing device 802 may also be one or more special-purpose processing devices such as an application specific integrated circuit (ASIC), a field programmable gate array (FPGA), a digital signal processor (DSP), a network processor, or the like. Processing device 802 is configured to execute instructions for performing any of the operations and steps discussed herein.

Computer system 800 may further include network interface device 812. Computer system 800 also may include video display 814 (e.g., a liquid crystal display (LCD) or a cathode ray tube (CRT)), one or more input devices 816 (e.g., a keyboard and/or a mouse), and one or more speakers 818. In one illustrative example, video display 814 and the input devices 816 may be combined into a single component or device (e.g., an LCD touch screen).

Data storage device 808 may include computer-readable medium 820 on which instructions 822 (e.g., implementing control system, user portal, and/or any functions performed by any device and/or component depicted in the FIGURES and described herein) embodying any one or more of the methodologies or functions described herein is stored. Instructions 822 may also reside, completely or at least partially, within main memory 804 and/or within processing device 802 during execution thereof by computer system 800. As such, main memory 804 and processing device 802 also constitute computer-readable media. Instructions 822 may further be transmitted or received over a network via network interface device 812.

While computer-readable storage medium 820 is shown in the illustrative example to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

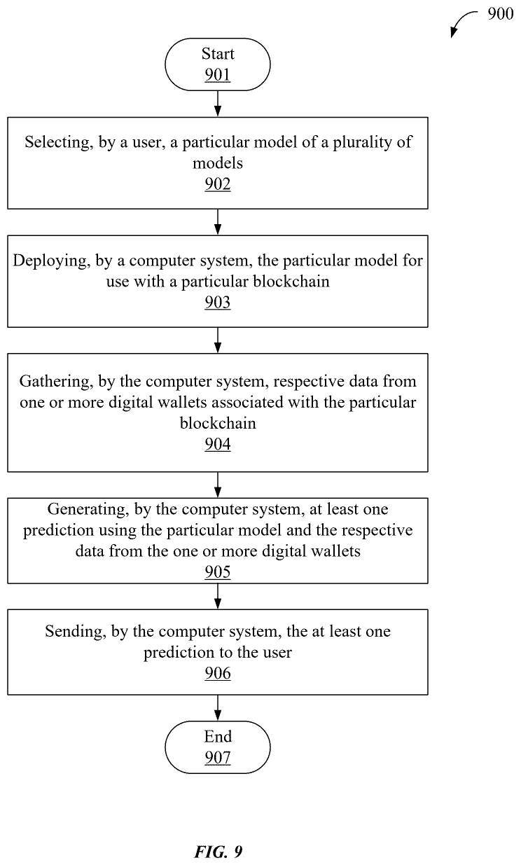

Turning to FIG. 9, a flow diagram depicting an embodiment of a method for analyzing blockchain data is illustrated. Method 900, which may be applied to various analysis systems, e.g., blockchain analysis system 100 as depicted in FIG. 1, begins in block 901.

Method 900 includes selecting, by a user, a particular model of a plurality of models (block 902). In some embodiments, selecting the particular model includes providing an authentication token to the user. In various embodiments, the authentication token is associated with an application programming interface endpoint associated with the particular model.

Method 900 further includes deploying, by a computer system, the particular model for use with a particular blockchain (block 903). In various embodiments, deploying the particular model may include retrieving data from the particular blockchain and analyzing the data using the particular model.

Method 900 also includes gathering, by the computer system, respective data from one or more digital wallets associated with the particular blockchain (block 904). In various embodiments, the blockchain analysis system may include an application programming interface or an oracle interface that allows the blockchain analysis system to access the particular blockchain.

Method 900 further includes generating, by the computer system, at least one prediction using the particular model and the respective data from the one or more digital wallets (block 905). In some embodiments, generating the at least one prediction includes predicting a duration a given digital wallet of the one or more digital wallets will hold a given token. In other embodiments, generating the at least one prediction includes predicting a likelihood that a given digital wallet of the one or more digital wallets is machine controlled. In various embodiments, generating the at least one prediction may include identifying, based on respective preferences of the one or more digital wallets, a subset of the one or more digital wallets.

Method 900 also includes sending, by the computer system, the at least one prediction to the user (block 906). In various embodiments, sending the at least one prediction may include sending the prediction via an e-mail message to the user. Alternatively, sending the at least one prediction may include sending, via an e-mail or text message, a link to a location, e.g., website, storing the prediction. In some cases, the location may also store a review of the particular model to be completed by the user.

In various embodiments, method 900 may also include collating review information for the particular model from one or more previous users of the particular model. As described below, review information, along with other information, may be used as part of the governance of the models and the blockchain analysis system. Method 900 concludes in block 907.

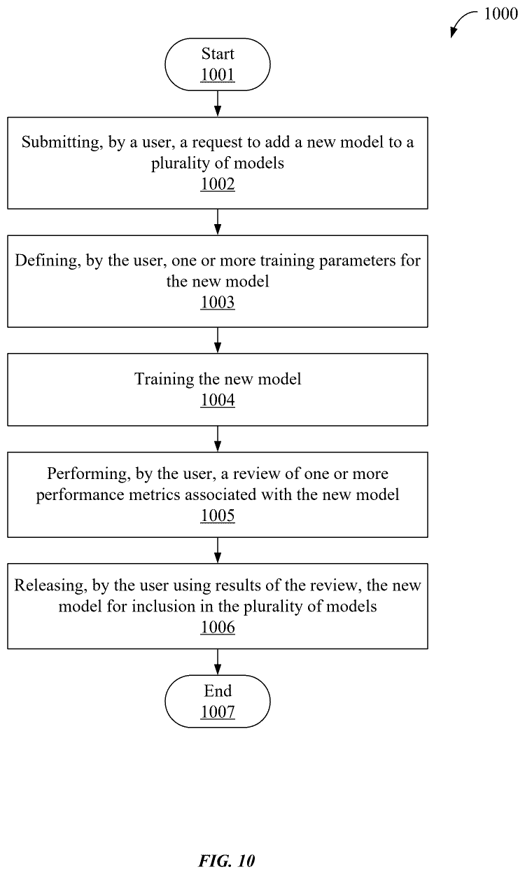

Turning to FIG. 10, a flow diagram depicting an embodiment of a method for adding a model to a system for analyzing blockchain data is illustrated. Method 1000, which may be applied to various systems, e.g., blockchain analysis system 100 as depicted in FIG. 1, begins in block 1001.

Method 1000 includes submitting, by a user, a request to add a new model to a plurality of models (block 1002). In some embodiments, submitting the request may include setting a prediction objective. In some cases, the prediction objective may include at least one variable. In some cases, the method may additionally include selecting, by the user, a validation methodology from multiple available validation methodologies. In other embodiments, submitting the request includes selecting a particular blockchain sector, and loading a general encoder corresponding to the particular blockchain sector.

Method 1000 further includes defining, by the user, one or more training parameters for the new model (block 1003). In various embodiments, the training parameters may include a size of the new model, a number of passes through training data, or any other suitable training parameters associated with training a machine-learning model.

Method 1000 also includes training the new model (block 1004). In various embodiments, training the new model may include adjusting one or more parameters included in the new model based on training data. Alternatively, or additionally, training the new model may include making a prediction using the new model operating on the training data, and adjusting the one or more parameters using results of the prediction.

Method 1000 further includes performing, by the user, a review of one or more performance metrics associated with the new model (block 1005). In various embodiments, the performance metrics may include an execution time, an accuracy of a prediction made by the model, or any other suitable performance metrics.

Method 1000 also includes releasing, by the user using results of the review, the new model for inclusion in the plurality of models (block 1006). In some cases, method 1000 may further include halting a release of the new model in response to determining at least one of the performance metrics indicate undesirable performance.

In some embodiments, method 1000 further includes associating collateral with the new model. In some cases, the collateral may include one or more utility tokens. Method 1000 concludes in block 1007.

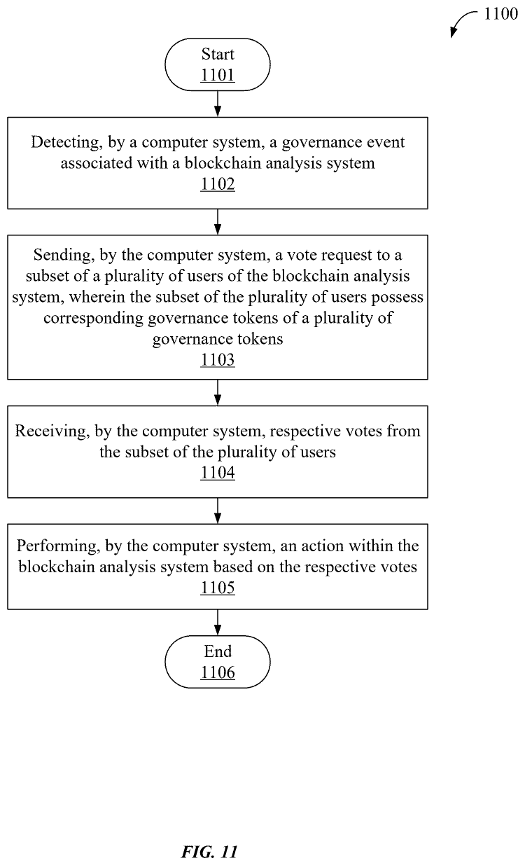

Turning to FIG. 11, a flow diagram depicting an embodiment of a method for governing a system for analyzing blockchain data is illustrated. Method 1100, which may be applied to various blockchain analysis systems, e.g., blockchain analysis system 100 as depicted in FIG. 1, begins in block 1101.

Method 1100 includes detecting, by a computer system, a governance event associated with a blockchain analysis system (block 1102). As described above, the blockchain analysis system includes a library of models, including a particular model used to generate a prediction using data from one or more digital wallets associated with a particular blockchain.

In some cases, the governance event may include adding a new model to the library of models. In other embodiments, the governance event may include removing an existing model from the library of models. In various embodiments, the governance event may include changing a number of utility tokens a user provides for an action within the blockchain analysis system. In different embodiments, the governance event may include changing a royalty associated with a particular model included in the library of models, where the particular model was requested by a particular user. Alternatively, or additionally, the governance event may include determining collateral associated with a model that has been removed from the library of models is to be released.

Method 1100 further includes sending, by the computer system, a vote request to a subset of a plurality of users of the blockchain analysis system (block 1103). In various embodiments, the subset of the plurality of users possess corresponding governance tokens of a plurality of governance tokens.

Method 1100 also includes receiving, by the computer system, respective votes from the subset of the plurality of users (block 1104). In various embodiments, a number of votes received from a given user of the plurality of users may correspond to a number of governance tokens in the given user's possession. In other embodiments, one user's vote may be weighted differently than another user's vote as part of a quadratic voting system.

Method 1100 further includes performing, by the computer system, an action within the blockchain analysis system based on the respective votes (block 1105). In some embodiments, performing the action may include removing a model from the library of models. In other embodiments, performing the action may include de-collateralizing a model that has been removed from the library of models. Alternatively, or additionally, performing the action may include changing a royalty for a particular model included in the library of models, or changing a cost, in terms of a number of utility tokens, for performing an action, such as requesting an analysis be performed. Method 1100 concludes in block 1106.

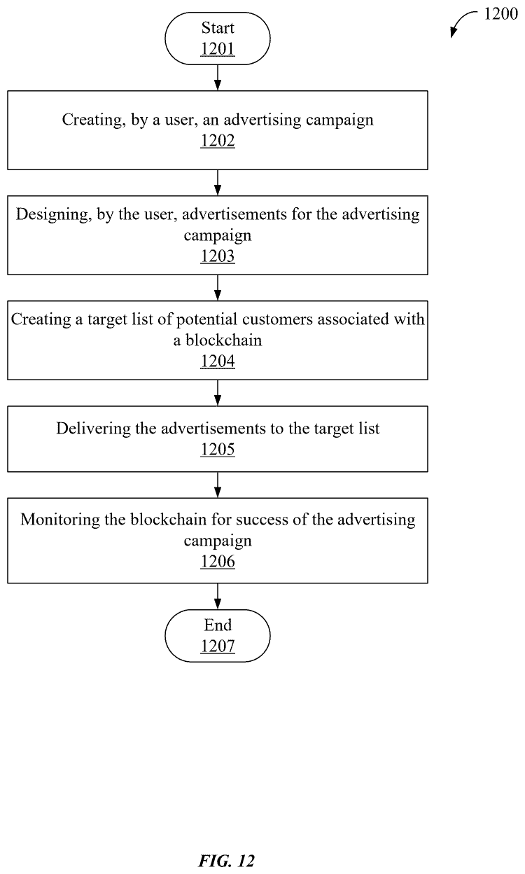

Turning to FIG. 12, a flow diagram depicting an embodiment of a method for generating advertising materials using a system for analyzing blockchain data is illustrated. Method 1200, which may be applied to various blockchain analysis systems, e.g., blockchain analysis system 100 as depicted in FIG. 1, begins in block 1201.

Method 1200 includes creating, by a user, an advertising campaign (block 1202). In some cases, creating the advertising campaign may include responding, by the user, to queries sent to the user from a chatbot or other interactive software. In various embodiments, creating the advertising campaign may include providing, by the user, at least one blockchain that includes one or more digital wallets or addresses that may be targets of the advertising campaign. In some embodiments, creating the advertising campaign may include specifying, by the user, a budget for the advertising campaign.

Method 1200 further includes designing, by the user, advertisements for the advertising campaign (block 1203). In some embodiments, designing the advertisements may include providing information to generative artificial intelligence tools. In some cases, the generative artificial intelligence tools may generate variations of the particular advertisement.

Method 1200 also includes creating a target list of potential customers associated with a blockchain (block 1204). In some embodiments, creating the target list of potential customers may include recommending, by a computer system, one or more potential customers based on data extracted from the at least one blockchain. In such cases, the method may also include reviewing, by the user, one or more potential customers.

Method 1200 further includes delivering the advertisements to the target list (block 1205). In various embodiments, delivering the advertisements may include sending the advertisements to the target list of potential customers. Such advertisements may be delivered to a given user when the given user is on another web platform once their identity has been established by observing the given user's wallet. In other embodiments, delivering the advertisements may include sending one or more links, via e-mail, text message, NFT, or any other suitable method, to the target list of potential customers.

Method 1200 also includes monitoring the blockchain for success of the advertising campaign (block 1206). In various embodiments, monitoring the blockchain may include retrieving data from one or more digital wallets associated with corresponding potential customers included in the target list of potential customers. The number of potential customers that convert to the advertised good or service after having received the advertisements may be compared to a threshold value. In cases where the number of potential customers that convert is greater than the threshold value, the advertising campaign may be designated as a success.

In some cases, operations included in blocks 1203-1206 may be repeated in response to determining the advertising campaign is unsuccessful. In various embodiments, before the operations in blocks 1203-1206 are repeated, the budget may be checked to verify there is still budget available. In some embodiments, the operations in blocks 1203-1206 may be repeated until all of the budget has been used. Method 1200 concludes in block 1207.

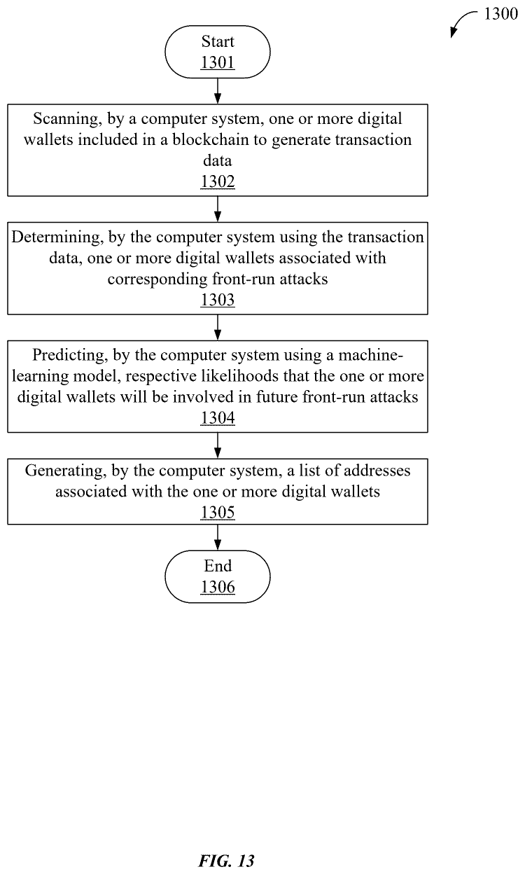

Turning to FIG. 13, a flow diagram depicting an embodiment of a method for identifying front-run attacks in a blockchain is illustrated. Method 1300, which may be applied to various blockchain analysis systems, e.g., blockchain analysis system 100 as depicted in FIG. 1, begins in block 1301.

Method 1300 includes scanning, by a computer system, one or more digital wallets included in a blockchain to generate transaction data (block 1302). In various embodiments, method 1300 may further include scanning the one or more digital wallets in response to receiving a request from a user.

Method 1300 further includes determining, by the computer system using the transaction data, one or more digital wallets associated with corresponding front-run attacks (block 1303). In various embodiments, determining the one or more digital wallets includes comparing a number of transactions associated with a given digital wallet of the one or more digital wallets to a first threshold value, where the transactions correspond to front-run attacks. In some embodiments, method 1300 further includes determining, by a user, the first threshold value.

Method 1300 also includes predicting, by the computer system using a machine-learning model, respective likelihoods that the one or more digital wallets will be involved in future front-run attacks (block 1304). In various embodiments, predicting the respective likelihoods includes predicting, by the computer system, a number of future front-run attacks for a given digital wallet of the one or more digital wallets, and comparing, by the computer system, the number of future front-run attacks to a second threshold value.

Method 1300 further includes generating, by the computer system, a list of addresses associated with the one or more digital wallets (block 1305). In some embodiments, method 1300 may also include sending the list of addresses to the user. In some embodiments, method 1300 may additionally include performing, by the computer system using the list of addresses and in response to a request from the user, a blocking action against at least one address included in the list of addresses.

Method 1300 concludes in block 1306. It is noted that the embodiment of the method depicted in FIG. 13 may be used in conjunction with any of the methods depicted in the flow diagrams of FIGS. 9-12 and 14-17.

The present embodiment is further defined in the following clauses:

Clause 13.1 A system, comprising: one or more memory circuits configured to store instructions, and one or more processors configured to receive the instructions from the one or more memory circuits and execute the instructions to cause the system to perform operations including:
scanning, by a computer system, one or more digital wallets included in a blockchain to generate transaction data;
determining, by the computer system using the transaction data, one or more digital wallets associated with corresponding front-run attacks;
predicting, by the computer system using a machine-learning model, respective likelihoods that the one or more digital wallets will be involved with future front-run attacks; and
generating, by the computer system, a list of addresses associated with the one or more digital wallets.

Clause 13.2 The system of clause 13.1, wherein scanning the one or more digital wallets includes scanning the one or more digital wallets in response to receiving a request from a user.

Clause 13.3 The system of clause 13.1, wherein determining the one or more digital wallets includes comparing a number of transactions associated with a given digital wallet of the one or more digital wallets to a first threshold value, wherein the transactions corresponding to front-run attacks.

Clause 13.4 The system of clause 13.3, wherein the operations further include determining, by a user, the first threshold value.

Clause 13.5 The system of clause 13.1, wherein predicting the respective likelihoods includes predicting, by the computer system, a number of future front-run attacks for a given digital wallet of the one or more digital wallets, and comparing, by the computer system, the number of future front-run attacks to a second threshold value.

Clause 13.6 The system of clause 13.1, wherein the operations further include performing, by the computer system using the list of addresses and in response to a request from the user, a blocking action against at least one address included in the list of addresses.

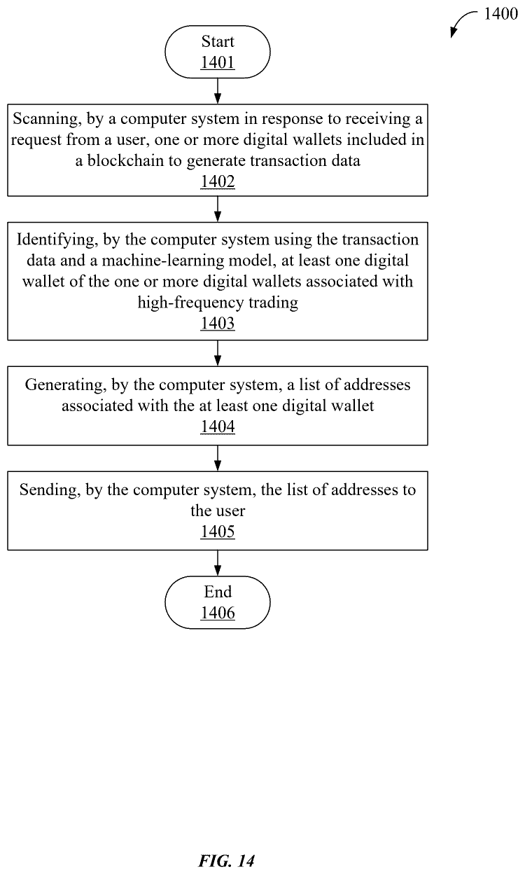

Turning to FIG. 14, a flow diagram depicting an embodiment of a method for identifying high-frequency trading addresses in a blockchain is illustrated. Method 1400, which may be applied to various blockchain analysis systems, e.g., blockchain analysis system 100 as depicted in FIG. 1, begins in block 1401.

Method 1400 includes scanning, by a computer system, one or more digital wallets included in a blockchain to generate transaction data (block 1402). In various embodiments, scanning the one or more digital wallets may include scanning the one or more digital wallets in response to receiving a request from a user.

Method 1400 also includes identifying, by the computer system using the transaction data and a machine-learning model, at least one digital wallet of the one or more digital wallets associated with high-frequency trading (block 1403). In various embodiments, identifying the at least one digital wallet may include determining a time period (or duration) that a given digital wallet of the one or more digital wallets holds a given token.

Method 1400 further includes generating, by the computer system, a list of addresses associated with the at least one digital wallet (block 1404). It is noted that the list of addresses may include addresses identified as performing high-frequency transactions as well as addresses identified as likely to perform front-run attacks in the future, or any other addresses identified by the computer system as potentially performing harmful actions to users of the blockchain.

Method 1400 also includes sending, by the computer system, the list of addresses to the user (block 1405). In some embodiments, method 1400 may include performing, by the computer system using the list of addresses and in response to a request from the user, a blocking action against at least one address included in the list of addresses.

Method 1400 concludes in block 1406. It is noted that the embodiment of the method depicted in FIG. 14 may be used in conjunction with any of the methods depicted in the flow diagrams of FIGS. 9-13 and 15-17.

The present embodiment is further defined in the following clauses:

Clause 14.1 A system comprising: one or more memory circuits configured to store instructions, and one or more processors configured to receive the instructions from the one or more memory circuits and execute the instructions to cause the system to perform operations including:
scanning, by a computer system in response to receiving a request by a user, one or more digital wallets included in a blockchain to generate transaction data;
identifying, by the computer system using a machine-learning model, at least one digital wallet of the one or more digital wallets associated with high-frequency trading;
generating, by the computer system, a list of addresses associated with the at least one digital wallet; and
sending, by the computer system, the list of addresses to the user.

Clause 14.2 The system of clause 14.1, wherein the operations further include selecting, by the user, the blockchain from a plurality of blockchains.

Clause 14.3 The system of clause 14.1, wherein identifying the at least one digital wallet includes determining a time period that a given digital wallet of the one or more digital wallets holds a given token.

Clause 14.4 The system of clause 14.1, wherein the list of addresses includes at least one address identified as likely to perform future front-run attacks.

Clause 14.5 The system of clause 14.1, wherein the operations further include performing, by the computer system using the list of addresses and in response to a request from the user, a blocking action against at least one address included in the list of addresses.

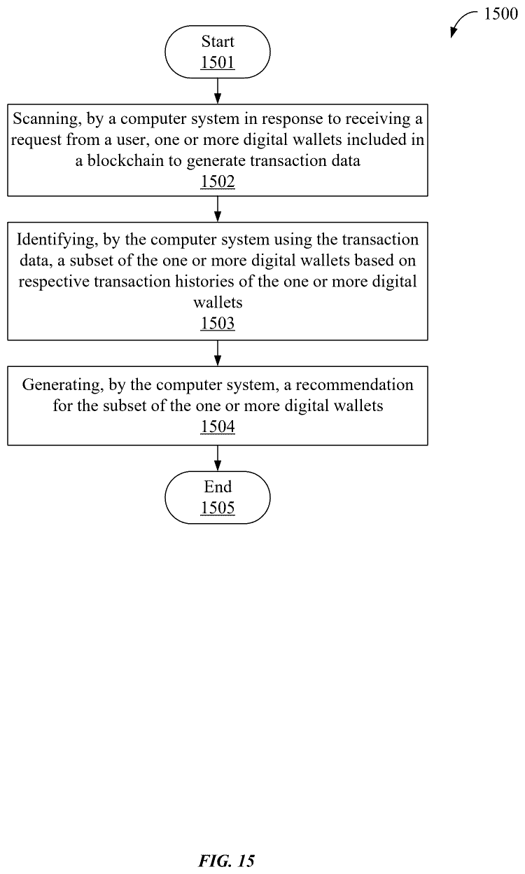

Turning to FIG. 15, a flow diagram depicting an embodiment of a method for grouping users of a blockchain is illustrated. Method 1500, which may be applied to various blockchain analysis systems, e.g., blockchain analysis system 100 as depicted in FIG. 1, begins in block 1501.

Method 1500 includes scanning, by a computer system in response to receiving a request from a user, one or more digital wallets included in a blockchain to generate transaction data (block 1502). In various embodiments, scanning the one or more digital wallets may include scanning the one or more digital wallets in response to the addition of a new digital wallet to the blockchain.

Method 1500 also includes identifying, by the computer system using the transaction data, a subset of the one or more digital wallets based on respective transaction histories of the one or more digital wallets (block 1503). In some embodiments, identifying the subset of the one or more digital wallets includes grouping the one or more digital wallets based on preferences in trading. In other embodiments, identifying the subset of the one or more digital wallets may include clustering the one or more digital wallets using the transaction data and according to a machine-learning model.

Method 1500 further includes generating, by the computer system, a recommendation for the subset of the one or more digital wallets (block 1504). In various embodiments, the recommendation may include a recommendation for a particular transaction. Alternatively, or additionally, the recommendation may include a recommendation for a news article, social media post, or the like.

In other embodiments, method 1500 may also include identifying a different subset of the one or more digital wallets. In such cases, method 1500 may include generating a different recommendation for the different subset. In other embodiments, method 1500 may include generating another recommendation for both subsets of the one or more digital wallets.

Method 1500 concludes in block 1505. It is noted that the embodiment of the method depicted in FIG. 15 may be used in conjunction with any of the methods depicted in the flow diagrams of FIGS. 9-14 and 16-17.

The present embodiment is further defined in the following clauses:

Clause 15.1 A system, comprising: one or more memory circuits configured to store instructions, and one or more processors configured to receive the instructions from the one or more memory circuits and execute the instructions to cause the system to perform operations including:
scanning, by a computer system, one or more digital wallets included in a blockchain to generate transaction data;
identifying, by the computer system using the transaction data, a subset of the one or more digital wallets based on respective transaction histories of the one or more digital wallets; and
generating, by the computer system, a recommendation for the subset of the one or more digital wallets.

Clause 15.2 The system of clause 15.1, wherein scanning the one or more digital wallets includes scanning the one or more digital wallets in response to the addition of a new digital wallet to the blockchain.

Clause 15.3 The system of clause 15.1, wherein identifying the subset of the one or more digital wallets includes grouping the one or more digital wallets based on preferences in trading.

Clause 15.4 The system of clause 15.1, wherein identifying the subset of the one or more digital wallets includes clustering the one or more digital wallets using the transaction data and according to a machine-learning model.

Clause 15.5 The system of clause 15.1, wherein the recommendation includes a recommendation for a particular transaction, a news article, or a social media post.

Clause 15.6 The system of clause 15.1, wherein the operations further include identifying a different subset of the one or more digital wallets, and generating a different recommendation for the different subset.

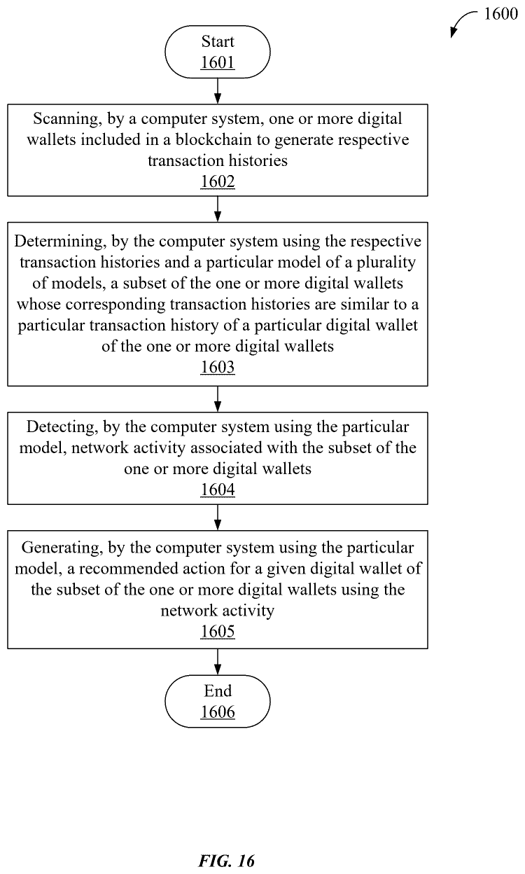

Turning to FIG. 16, a flow diagram depicting an embodiment of a method for cluster-based trading using digital wallets included in a blockchain is illustrated. Method 1600, which may be applied to various blockchain analysis systems, e.g., blockchain analysis system 100 as depicted in FIG. 1, begins in block 1601.

Method 1600 includes scanning, by a computer system, one or more digital wallets included in a blockchain to generate respective transaction histories (block 1602). In various embodiments, the method may further include scanning the one or more digital wallets in response to receiving a request from a user.

Method 1600 further includes determining, by the computer system using the respective transaction histories and a particular model of a plurality of models, a subset of the one or more digital wallets whose corresponding transactions histories are similar to a particular transaction history of a particular digital wallet of the one or more digital wallets (block 1603). In some embodiments, the particular model may be a machine-learning model or any suitable model that can used by a computer system.

Method 1600 also includes detecting, by the computer system using the particular model, network activity associated with the subset of the one or more digital wallets (block 1604). In various embodiments, the network activity can include a transfer of data packets between different ones of the subset of the one or more digital wallets.

Method 1600 further includes generating, by the computer system using the particular model, a recommended action for a given digital wallet of the subset of the one or more digital wallets using the network activity (block 1605). In some embodiments, the recommended action may include selling or trading a given NFT, or any other suitable action.

Method 1600 concludes in block 1606. It is noted that the embodiment of the method depicted in FIG. 16 may be used in conjunction with any of the methods depicted in the flow diagrams of FIGS. 9-15 and 17.

The present embodiment is further defined in the following clauses:

Clause 16.1 A system, comprising: one or more memory circuits configured to store instructions, and one or more processors configured to receive the instructions from the one or more memory circuits and execute the instructions to cause the system to perform operations including:
scanning, by the system, one or more digital wallets included in a blockchain to generate respective transaction histories;
determining, by the system using the respective transaction histories and a particular model of a plurality of models, a subset of the one or more digital wallets whose corresponding transactions histories are similar to a particular transaction history of a particular digital wallet of the one or more digital wallets;
detecting, by the system using the particular model, network activity associated with the subset of the one or more digital wallets; and
generating, by the computer system using the particular model, a recommended action for a given digital wallet of the subset of the one or more digital wallets using the network activity.

Clause 16.2 The system of clause 16.1, wherein scanning the one or more digital wallets includes scanning the one or more digital wallets in response to receiving a request from a user.

Clause 16.3 The system of clause 16.1, wherein the particular model may be a machine-learning model or any suitable model that can be used by a computer system.

Clause 16.4 The system of clause 16.1, wherein the network activity can include a transfer of data packets between different ones of the subset of the one or more digital wallets.

Clause 16.5 The system of clause 16.1, wherein the recommended action may include selling or trading a given NFT, or any other suitable action.

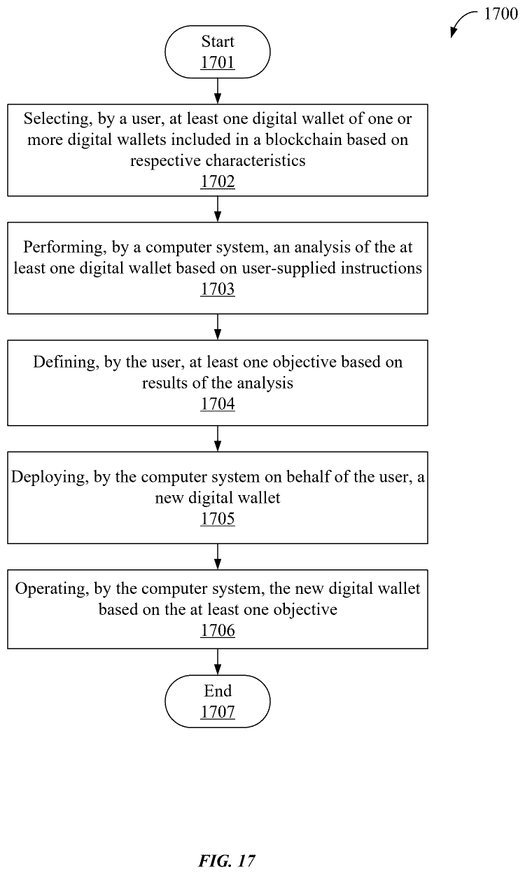

Turning to FIG. 17, a flow diagram depicting an embodiment of a method for agent-based trading using digital wallets included in a blockchain is illustrated. Method 1700, which may be applied to various blockchain analysis systems, e.g., blockchain analysis system 100 as depicted in FIG. 1, begins in block 1701.

Method 1700 includes selecting, by a user, at least one digital wallet of one or more digital wallets included in a blockchain based on respective characteristics (block 1702). In various embodiments, the method may further include receiving, by a computer system, information indicative of a selection of the at least one digital wallet from the user.

Method 1700 further includes performing, by a computer system, an analysis of the at least one digital wallet based on user-supplied instructions (block 1703). In some embodiments, performing the analysis may include tracking a number of transactions associated with the at least one digital wallet.

Method 1700 also includes defining, by the user, at least one objective based on results of the analysis (block 1704). In various embodiments, the at least one objective may include a particular number of trades, a net increase in value in the holdings of a given digital wallet, or any other suitable objective.

Method 1700 further includes deploying, by the computer system on behalf of the user, a new digital wallet (block 1705). In some embodiments, deploying the new digital wallet includes adding the new digital wallet to the blockchain. In other embodiments, method 1700 may include deploying a plurality of new digital wallets along with corresponding instructions for a plurality of users.

Method 1700 also includes operating, by the computer system, the new digital wallet based on the at least one objective (block 1706). In various embodiments, operating the new digital wallet may include performing at least one trade with the new digital wallet.

Method 1700 concludes in block 1707. It is noted that the embodiment of the method depicted in FIG. 17 may be used in conjunction with any of the methods depicted in the flow diagrams of FIGS. 9-16.

The present embodiment is further defined in the following clauses:

Clause 17.1 A system, comprising: one or more memory circuits configured to store instructions, and one or more processors configured to receive the instructions from the one or more memory circuits and execute the instructions to cause the system to perform operations including:
selecting, by a user, at least one digital wallet of one or more digital wallets included in a blockchain based on respective characteristics;
performing, by the system, an analysis of the at least one digital wallet based on user-supplied instructions;
defining, by the user, at least one objective based on results of the analysis;
deploying, by the system on behalf of the user, a new digital wallet; and
operating, by the system, the new digital wallet based on the at least one objective.

Clause 17.2 The system of clause 17.1, wherein the operations further include receiving, by the system, information indicative of a selection of the at least one digital wallet from the user.

Clause 17.3 The system of clause 17.2, wherein performing the analysis may include tracking a number of transactions associated with the at least one digital wallet.

Clause 17.4 The system of clause 17.3, wherein the at least one objective may include a particular number of trades, a net increase in value in the holdings of a given digital wallet, or any other suitable objective.

Clause 17.5 The system of clause 17.4, wherein deploying the new digital wallet includes adding the new digital wallet to the blockchain.

Clause 17.5 The system of clause 17.5, wherein the operations further include deploying a plurality of new digital wallets along with corresponding instructions for a plurality of users.

Clause 17.6 The system of clause 17.6, wherein operating the new digital wallet may include performing at least one trade with the new digital wallet.

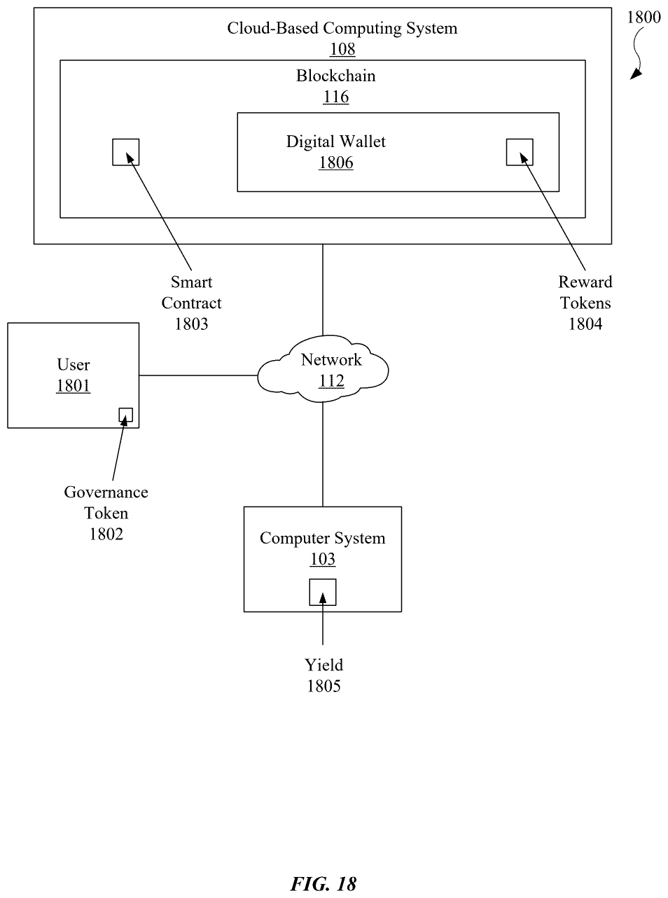

Decentralized revenue sharing is an incentive for participation in a blockchain ecosystem. A block diagram illustrating decentralized revenue sharing is depicted in FIG. 18.

As illustrated, in FIG. 18, user 1801 can acquire governance token 1802. In various embodiments, governance token 1802 may correspond to any of governance tokens 304-306 as depicted above.

User 1801 may stake governance token 1802. As used herein, staking refers to a process by which a user can lock one or more tokens in their digital wallet included in a blockchain. In some cases, staking governance token 1802 may include sending governance token 1802 to smart contract 1803 that is included in blockchain 116. Although user 1801 is depicted as staking a governance token in the embodiment of FIG. 18, in other embodiments, user 1801 may stake any other suitable type of token.

Computer system 103 may be configured to generate yield 1805 based on tokens, e.g., governance token 1802, that are staked by user 1801, and respective durations which the tokens have been staked. In some embodiments, yield 1805 may correspond to a number of utility tokens per governance token staked by the user. In some cases, yield 1801 can be calculate in a linear fashion as shown in Equation 1, where t is a number of seconds since staking rewards began accruing, Yₘᵢₙ is the initial issuance rate, Yₘₐₓ is the target issuance rate to be reached after a predetermined period, Tₘᵢₙ is the initial period during which no rewards are earned, and Tₘₐₓ is the number of seconds until the yield reaches Yₘₐₓ.

$$Y ( t ) = \{ \begin{matrix}{Y}_{m i n} + \frac{t}{T} ( {Y}_{m ax} - {Y}_{m i n} ) & {T}_{m i n} \leq t \leq {T}_{m ax} \\ {Y}_{m ax} & t > T\end{matrix} \qquad ( 1 )$$

In addition to a linear approach, yield 1801 may be determine in a non-linear fashion. Such a non-linear model may, in various embodiments, offer steeper yield increase or more controlled emission growth under certain market conditions. An example of a non-linear yield calculation is shown in Equation 2, where t is the number of seconds since staking began, Yₘᵢₙ is the initial issuance rate, Yₘₐₓ is the target issuance rate, k is a steepness parameter that controls how quickly the function transitions from Yₘᵢₙ to Yₘₐₓ.

$$Y ( t ) = {Y}_{m i n} + \frac{{Y}_{m ax} - {Y}_{m i n}}{1 + {e}^{- k ( t - \frac{t}{2} )}} \qquad ( 2 )$$

Although only two yield equations are disclosed, other equations for generating yield 1801 are possible and contemplated. It is noted that although yield 1801 is depicted as being generated by computer system 103, in some embodiments, yield 1801 may be determined by cloud-based computing system 108.

In various embodiments, user 1081 may claim a reward based on the yield 1805. In some cases, the reward includes reward tokens 1804. In different embodiments, reward tokens 1804 may of a different token type than governance token 1802. For example, reward tokens 1804 may be utility tokens. In other embodiments, computer system 103 may be further configured to place reward tokens 1804 in digital wallet 1806 included blockchain 116, where digital wallet 1806 is associated with user 1801.

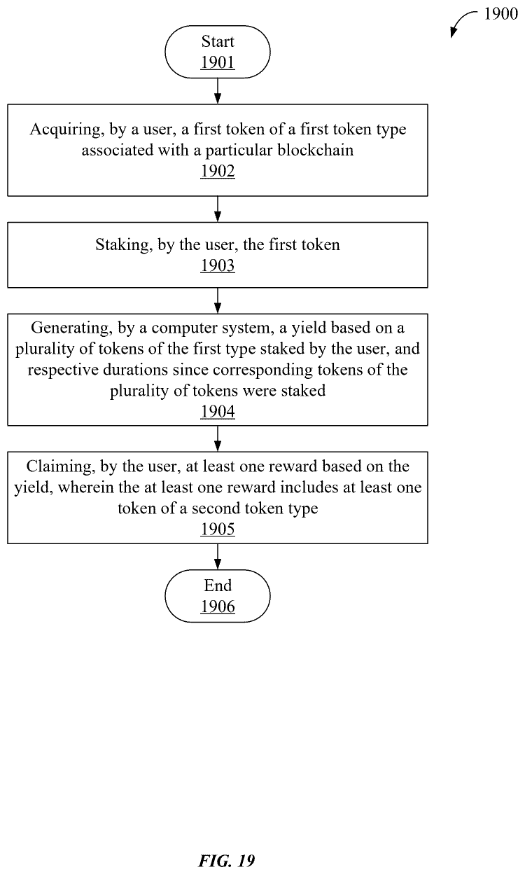

Turning to FIG. 19, a flow diagram depicting an embodiment of a method for decentralized revenue sharing for a blockchain is illustrated. Method 1900, which may be applied to various blockchain analysis systems, e.g., blockchain analysis system 100 as depicted in FIG. 1, begins in block 1901.

Method 1900 includes acquiring, by a user, a first token of a first token type associated with a particular blockchain (block 1902). In various embodiments, the first token type may correspond to a governance token type such as described above.

Method 1900 also includes staking, by the user, the first token (block 1903). In some embodiments, staking the first token includes sending the first token to a smart contract such as those described above.

Method 1900 further includes generating, by a computer system, a yield based on a plurality of tokens of the first type staked by the user, and respective durations since corresponding tokens of the plurality of tokens were staked (block 1904). In some embodiments, generating the yield may include determining a different between a target issuance rate and an initial issuance rate. In other embodiments, generating the yield may include setting the yield to the target issuance rate after a threshold time period has elapsed since staking a given token of the plurality of tokens.

Method 1900 also includes claiming, by the user, at least one reward based on the yield (block 1905). In various embodiments, the at least one reward includes at least one token of a second token type, different than the first token type. In some embodiments, the second token type may correspond to a utility token type. In other embodiments, method 1900 may further include sending the at least one token to a digital wallet included in the particular blockchain, wherein the digital wallet is associated with the user.

Method 1900 concludes in block 1906. It is noted that the embodiment of the method depicted in FIG. 19 may be used in conjunction with any of the methods depicted in the flow diagrams of FIGS. 9-17.

The present embodiment is further defined in the following clauses:

Clause 19.1 A system, comprising: one or more memory circuits configured to store instructions, and one or more processors configured to receive the instructions from the one or more memory circuits and execute the instructions to cause the system to perform operations including:
acquiring, by a user, a first token of a first token type associated with a particular blockchain;
staking, by the user, the first token;
generating, by a computer system, a yield based on a plurality of tokens of the first type staked by the user, and respective durations since corresponding tokens of the plurality of tokens were staked;
claiming, by the user, at least one reward based on the yield.

Clause 19.2 The system of clause 19.1, wherein the first token type corresponds to a governance token type such as described above.

Clause 19.3 The system of clause 19.1, wherein staking the first token includes sending the first token to a smart contract associated with the particular block chain.

Clause 19.4 The system of clause 19.1, wherein generating the yield may include determining a different between a target issuance rate and an initial issuance rate.

Clause 19.5 The system of clause 19.4, wherein generating the yield includes setting the yield to the target issuance rate after a threshold time period has elapsed since staking a given token of the plurality of tokens.

Clause 19.6 The system of clause 19.5, wherein generating the yield includes setting the yield to the target issuance rate after a threshold time period has elapsed since staking a given token of the plurality of tokens.

Clause 19.7 The system of clause 19.1, wherein the at least one reward includes at least one token of a second token type, different than the first token type.

Clause 19.8 The system of clause 19.7, wherein the operation further include sending the at least one token to a digital wallet included in the particular blockchain, wherein the digital wallet is associated with the user.

Clause 19.9 The system of clause 19.7, wherein the second token type corresponds to a utility token type.

None of the descriptions in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle.

What is claimed is:

1. A method, comprising:
selecting, by a user, a particular model of a plurality of models;
deploying the particular model for use with a particular blockchain;
gathering respective data from one or more digital wallets associated with the particular blockchain;
generating at least one prediction using the particular model and the respective data from the one or more digital wallets; and
sending the at least one prediction to the user.

2. The method of claim 1, wherein generating the at least one prediction includes predicting a duration a given digital wallet of the one or more digital wallets will hold a given token.

3. The method of claim 1, wherein generating the at least one prediction includes predicting a likelihood that a given digital wallet of the one or more digital wallets is machine controlled.

4. The method of claim 1, wherein generating the at least one prediction includes identifying, based on respective preferences of the one or more digital wallets, a subset of the one or more digital wallets.

5. The method of claim 1, wherein selecting the particular model includes providing an authentication token to the user, wherein the authentication token is associated with an application programming interface endpoint associated with the particular model.

6. The method of claim 1, further comprising collating review information for the particular model from one or more previous users of the particular model.

7. A system, comprising:
one or more memory circuits configured to store instructions; and
one or more processors configured to receive the instructions from the one or more memory circuits and execute the instructions to cause the system to perform operations including:
submitting, by a user, a request to add a new model to a plurality of models;
defining, by the user, one or more training parameters for the new model;
training the new model;
performing, by the user, a review of one or more performance metrics associated with the new model; and
releasing, by the user and using results of the review, the new model for inclusion in the plurality of models.

8. The system of claim 7, wherein the operations further include associating collateral with the new model.

9. The system of claim 7, wherein submitting the request includes setting a prediction objective for the new model, wherein the prediction objective includes at least one variable.

10. The system of claim 7, wherein defining the one or more training parameters includes selecting a cost associated with the training.

11. The system of claim 7, wherein the operations further include selecting, by the user, a validation methodology from a plurality of validation methodologies.

12. The system of claim 11, wherein the operations further include recommending a particular validation methodology of the plurality of validation methodologies based on at least one data structure specified in the new model.

13. The system of claim 7, wherein submitting the request includes selecting a particular blockchain sector, and loading a general encoder corresponding to the particular blockchain sector.

14. A tangible non-transitory computer-readable medium having program instruction stored therein that, in response to execution by a computer system, causes the computer system to perform operations including:
detecting, by the computer system, a governance event associated with a blockchain analysis system;
sending, by the computer system, a vote request to a subset of a plurality of users of the blockchain analysis system, wherein the subset of the plurality of users of the blockchain analysis system possess corresponding governance tokens of a plurality of governance tokens;
receiving, by the computer system, respective votes from the subset of the plurality of users; and
performing, by the computer system, an action within the blockchain analysis system based on the respective votes.

15. The tangible non-transitory computer-readable medium of claim 14, wherein the blockchain analysis system includes a library of models including a particular model used to generate a prediction using data from one or more digital wallets associated with a particular blockchain, and wherein the governance event includes adding a new model to the library of models.

16. The tangible non-transitory computer-readable medium of claim 15, wherein the governance event further includes removing an existing model from the library of models.

17. The tangible non-transitory computer-readable medium of claim 15, wherein the governance event includes changing a number of utility tokens a user provides for an action within the blockchain analysis system.

18. The tangible non-transitory computer-readable medium of claim 15, wherein the governance event includes changing a royalty associated with a particular model included in the library of models, wherein the particular model was requested by a particular user.

19. The tangible non-transitory computer-readable medium of claim 15, wherein the governance event includes releasing collateral associated with a particular model included in the library of models.

20. The tangible non-transitory computer-readable medium of claim 14, wherein the operations further include receiving the respective votes according to a quadratic voting system.
